(19) United States
(12) Patent Application Publication
(10) Pub. No.: US 2002/0039427 A1
(43) Pub. Date: Apr. 4, 2002

(54) Audio apparatus

(76) Inventors: Timothy Whitwell, Cambs (GB); Malcolm John Hawksford, Essex (GB); Robin Christopher Cross, Suffolk (GB)

Correspondence Address: Alan I. Cantor, FOLEY & LARDNER, Washington Harbour, 3000 K Street, N.W., Suite 500, Washington, DC, 20007-5570, US

(21) Appl. No.: 09/969,028

(22) Filed: Oct. 3, 2001

Related U.S. Application Data
(60) Provisional application No. 60/237,683, filed on Oct. 5, 2000.

(30) Foreign Application Priority Data
Oct. 4, 2000 (GB) 0024279.2

(51) Int. Cl. H04R 25/00

(52) U.S. Cl. 381/312; 381/315; 381/328

(57) ABSTRACT

Audio apparatus (50) comprising a transducer and a coupler for coupling the transducer to a user's pinna. The coupler may be in the form of a hook (56), and leads (58) connect the audio apparatus (50) to a remote sound source. The transducer (52) is mounted to a lower straight end of the hook (56). An upper curved end of the hook (56) hooks over the junction between the user's ear and head so that the transducer (52) touches a lower rear face of the pinna adjacent the concha. The transducer excites vibration in the pinna whereby an acoustic signal from the transducer is transmitted to the user's inner ear by radiation of pressure waves and/or by conduction of vibrational energy through the outer and middle ear.

This application claims the benefit of provisional application No. 60/237,683, filed Oct. 5, 2000.

### TECHNICAL FIELD

The invention relates to audio apparatus and, more particularly, to audio apparatus for personal use.

### BACKGROUND ART

It is known to provide earphones which may be inserted into a user's ear cavity, or headphones comprising a small loudspeaker mounted on a headband and arranged to be placed against or over the user's ear. Such sound sources transmit sound to a user's inner ear via the ear drum using air pressure waves passing along the ear canal.

There are disadvantages associated with both headphones and earphones. For example, they may obstruct normal auditory process such as conversation or may prevent a user from hearing useful or important external audio information, e.g. a warning. Furthermore, they are generally uncomfortable and if the volume of the sound being transmitted is too high they may cause auditory overload and damage.

An alternative method of supplying sound to a user's inner ear is to use bone conduction as, for example, in some types of hearing aids. In this case, a transducer is fixed to a user's mastoid bone so as to be mechanically coupled to the user's skull. Sound is then transmitted from the transducer through the skull and directly to the cochlea or inner ear. The eardrum is not involved in this sound transmission route. Locating the transducer behind the ear provides good mechanical coupling.

One disadvantage of this arrangement is that the mechanical impedance of the skull at the location of the transducer is a complex function of frequency. Thus, the design of the transducer and the necessary electrical equalisation may be expensive and difficult.

### SUMMARY OF THE INVENTION

Audio apparatus comprising a transducer and a coupling means for coupling the transducer to a user's pinna whereby the transducer excites vibration in the pinna to cause it to transmit an acoustic signal from the transducer to a user's inner ear. The pinna is the whole of a user's outer ear. The transducer may, for example, be coupled directly to a user's earlobe or to a rear face of a user's pinna adjacent to the user's concha.

When directly exciting the ear, there are two mechanisms for generating velocity at the ear drum, namely by radiation of pressure waves to the eardrum or by conduction of vibrational energy to the eardrum through the structures of the outer and middle ear. The vibration of the pinna may have a distribution which allows a mix of near-field direct sound radiation and mechanical coupling to the pinna, particularly to an outer wall of the ear canal. Thus the acoustic signal may be transmitted by radiation of pressure waves and/or by conduction of vibrational energy through the outer and middle ear. For conduction, the cylindrical ear canal surface may act as a transmission path for mechanical energy and thus may be considered to be vibrating as a stiff cylinder.

The transducer may provide an input force which may be translated to the eardrum equally by both mechanisms. The translation or transmission of the force may be independent of the mechanical impedance at the drive point. At low frequencies, i.e. below 1 kHz, the principal mechanism may be conduction rather than radiation and thus a user may experience a slight tingling sensation. This may result in a perceived difference between the low frequency response as measured by subjective loudness balance and that experienced by a user. At high frequencies, i.e. above 1 kHz, the principal mechanism may be radiation rather than conduction.

The transducer is preferably a wide bandwidth low driving mass transducer which may be of the type used in distributed mode acoustic radiators of the general kind described in International patent application WO97/09842 and U.S. counterpart application Ser. No. 08/707,012, filed Sep. 3, 1996 (the latter incorporated herein by reference). Such a transducer may thus be effective when coupled to a moderate and largely resistive mechanical impedance, for example a typical pinna which is composed of a mixture of cartilage, skin and other connective tissue.

The transducer may be of any suitable kind, e.g. inertial or grounded vibration transducer, actuator or exciter, e.g. moving coil transducer, a piezoelectric transducer, a magnetostrictive transducer, a bender or torsional transducer (e.g. of the type taught in WO00/13464 and U.S. counterpart application Ser. No. 09/384,419, filed Aug. 27, 1999 (the latter incorporated herein by reference)) or a distributed mode transducer (e.g. of the type taught in WO01/54450 and U.S. counterpart application Ser. No. 09/768,002, filed Jan. 24, 2001 (the latter incorporated herein by reference)).

The transducer may preferably have a diameter so that the transducer may be comfortably mounted on the pinna. The diameter may be less than 20 mm. The diameter may be less than 15 mm. A smaller transducer generally performs less well than a larger transducer at low frequency and thus the low frequency performance of smaller transducers may be improved by adjusting the suspension compliance and/or magnet mass. The transducer may be configured to produce a high field strength magnetic circuit so as to provide good sensitivity.

The transducer may be mechanically coupled to the pinna by coupler which may be in the form of a mesh cover screen. The coupler may be shaped to fit the shape of a user's ear. The coupler may have a lattice structure whereby acoustic radiation therefrom is minimised. The coupler preferably has low mass and high stiffness in the direction of the force from the transducer, whereby mechanical force to the pinna is maximised.

The audio apparatus may comprise a built-in facility to locate the optimum location of the transducer on the pinna for each individual user. The optimum location may provide optimal tonal balance or may optimise other features of the acoustic response. By optimising the location of the transducer, the pinna and the transducer may in effect form a combined driver which is unique to an individual user. The audio apparatus may be adapted to provide a subjectively neutral frequency response over a broad frequency range.

The audio apparatus may resemble a clip-on earring. The coupling means may be in the form of a spring clip or a clamp. The tension in the spring or the pressure exerted by the clamp may be adjusted to ensure good mechanical coupling between the pinna and the transducer, and/or user comfort. The coupling means may be modified for those with pierced ears.

The audio apparatus may also comprise a pad which may provide additional user comfort. The coupling means may couple the transducer to a first face of the pinna and the pad to a second face of the pinna. The audio apparatus may comprise a second transducer mounted at a second location on the pinna. The transducers may be mounted on opposing faces of the pinna. The audio apparatus may comprise more than two transducers, each mounted at different locations on the pinna. Each transducer may be connected to different signals.

An alternative coupling means is in the form of a hook, an upper end of which hooks over an upper surface of the pinna and a lower end on which the transducer is mounted, whereby the transducer contacts a lower part of the pinna, for example the ear lobe. The hook may be made of metal, plastics or rubberised material. The upper end of the hook may be curved and the lower end of the hook may be straight.

The transducer may be slidably mounted on the lower end of the hook so that the transducer may be moved up or down the lower end. The upper end of the hook may be rotatable relative to the transducer. Thus, the position of the transducer relative to a user's ear and the position of the upper end of the hook may be adjusted for comfort and for optimum performance. Alternatively, or additionally, the hook shape may be engineered to produce a firm contact to the pinna to ensure good mechanical coupling between the pinna and transducer.

A user may use two audio apparatuses, one mounted on each ear. The signal input may be different to each audio apparatus. For example, each audio apparatus may be supplied with an appropriate stereo channel to create a correlated stereo image. Since the sound source is localised naturally at the side of the head, a pleasing, open and effective stereo image may be created. Alternatively, the signal input may be the same for both audio apparatuses. Thus, higher intelligibility for a single channel of information may be achieved.

The audio apparatus may further comprise a miniature built in microphone, e.g. for hands-free telephony, to make an attractive, comfortable and convenient assembly.

The audio apparatus may further comprise a built-in micro receiver, for example, for a wireless link to a local source, e.g. a CD player or a telephone, or to a remote source for broadcast transmissions.

A pair of audio apparatuses may be combined with conventional headphones to create novel spatial effects for the listener by suitable signal type and/or processing. For example, such a combination may provide a method for providing four distinguishable channels of audio data to the user.

The audio apparatus may further comprise a radio and/or telephone link device.

According to a second aspect of the invention, there is provided a method of applying an audio signal to a human or animal subject comprising mechanically coupling a transducer to a user's pinna and driving the transducer so that the transducer excites vibration in the pinna to cause it to transmit an acoustic signal from the transducer to the subject's inner ear.

The required acoustic signal may be transmitted by radiation of acoustic pressure waves and/or by conduction of vibrational energy through the outer and middle ear. The method may comprise grasping a flap of the pinna, e.g. the ear lobe, and applying a stimulus signal mechanically to the flap, e.g. to a grasped portion of the flap. Alternatively, the method may comprise mounting the transducer to a rear face of the pinna.

The method may comprise adjusting the location of the transducer on the pinna for each individual user to optimise acoustic performance, for example to provide optimal tonal balance. The optimal position may be measured by determining the angle between a horizontal axis extending through the entrance to the ear canal and a radial line which extends through the entrance and which corresponds to the central axis of the transducer. The angle may be in the range of 9 to 41 degrees of declination.

The advantages of embodiments of the invention may include some or all of the following:

1) There may be no or little obstruction of the normal auditory process so that conversation or audible warnings may be easily heard. Thus a user or wearer may be connected via the audio apparatus to a communications system at the same time as being fully connected to the ambient surroundings. The audio apparatus may thus be considered spatially transparent and may be considered to combine the real world (i.e. ambient surrounding) with the virtual world (i.e. sound source). Personal safety may be maintained, whilst music and other sounds are presented to the inner ear.

Thus the audio apparatus may be used in applications where it is essential that a user receive communication or commentary without loss of normal hearing, e.g. in military communications, including battlefield applications, in factory floor applications, in museums or in car personal stereos. Furthermore, the audio apparatus may be used in commercial applications where it is desirable for a user to receive communication or commentary without loss of normal hearing, e.g. teleconferencing, call centres, receptionist or secretarial applications, stock market and dealing applications or supermarket checkouts.

2) Since there are two mechanisms for generating velocity at the ear drum, the open ear canal may be fitted with an earplug. The ear plug will reduce ambient sound and boost the sound from the audio apparatus and thus may be particularly suitable for noisy environments.

3) Instead of clamping a transducer to the head or inserting it into the ear canal, the audio apparatus allows for a convenient, non-invasive and more hygienic use by the user. This also contrasts with a conventional headphone which is likely to become sweaty or uncomfortable during continued use. Furthermore, in contrast to some commercial in-ear designs, since the audio apparatus is non-invasive, there is no need to shape the apparatus to match a user's concha and ear canal.

4) Furthermore, the audio apparatus may be manufactured from low cost, lightweight materials and may thus be disposable. The disposability may be an advantage where hygiene is paramount, e.g. conference use. Alternatively, the apparatus may be used in cinemas in addition to the conventional audio wall speakers since the combination may alleviate limitations of auditorium acoustics.

5) The invention is free of the sensations of physical and acoustic pressure effects produced by conventional earphones. The sonic experience which the audio apparatus generates may thus be different from that of conventional headphones or earphones. For example, exploiting the human pinna as an acoustic pathway may aid natural hearing while providing a more compelling and relaxed listening experience.

6) Auditory overload and damage is virtually impossible due to the lossy coupling imparted by the pinna. It is possible, however, that at very high loudness a slight tingling may be felt in the ear lobes which some users may find disconcerting. As a result of such tingling the audio apparatus is likely to become physically uncomfortable at an input level below that at which the audio apparatus becomes too loud. Thus high sound pressure levels directly into ear canal may be avoided.

7) Driving the pinna with a constant force transducer is surprisingly effective in the audio range. For example, powers of perhaps one tenth of those used for speaker reproduction produce good perceived loudness. Moreover, the quality is high with low distortion and good clarity. There is a wide perceived bandwidth which may extend well into the low bass range depending on the transducer size and intrinsic response.

The potential benefits of the device are thus wide ranging. The audio apparatus and method may be used in private applications, e.g. in-car use where the information provided to a user could include navigation data and/or audible instrument read-out, or as an alternative to a pair of loudspeakers for a computer, particularly portable computers, or in mobile teleconferencing and communications or as a companion to video head-up displays. Other applications may include television studio and theatre stage communications, for example actors or musicians may wear the audio apparatus for prompting or fold back whereby the actor or musician may hear an amplified version of his own voice or instrument.

### BRIEF DESCRIPTION OF THE DRAWINGS

Examples that embody the best mode for carrying out the invention are described in detail below with reference to the accompanying drawings, in which:

FIG. 1 is a schematic perspective view of audio apparatus according to the present invention in place on a user's ear;

FIG. 2 is an underside plan view of the audio apparatus of FIG. 1;

FIG. 3 is a perspective view of the audio apparatus of FIG. 1 shown without an ear;

FIG. 4 is an underside plan view of a second alternative embodiment of audio apparatus according to the present invention;

FIG. 5 is a perspective view of a third embodiment of audio apparatus according to the present invention;

FIG. 6 is a rear perspective view of a fourth embodiment of the audio apparatus in position on a user's ear;

FIG. 7 is a schematic perspective view of the audio apparatus of FIG. 6;

FIG. 8 is an exploded perspective view of the audio apparatus of FIG. 6;

FIG. 9a is a top plan view of a coupler of an audio apparatus according to the invention;

FIG. 9b is a side view of the coupler of FIG. 9a;

FIG. 10 is a side elevational view of a user's ear on which an audio apparatus is mounted in a preferred position;

FIG. 11 is a perspective view of a pair of the audio apparatuses of FIG. 6;

FIG. 12 is a graph of the frequency response of an audio apparatus according to the present invention;

FIG. 13 is an attenuation curve for a headset comprising supra-aural earphones;

FIG. 14 is an attenuation curve for a headset comprising supra-concha earphones;

FIG. 15 is an attenuation curve for a headset comprising intra-concha earphones;

FIG. 16 is a graph of speech transmission index against sound pressure level;

FIG. 17 is a graph of octave modulation transfer index at 32 dBA against frequency measured in Hz;

FIG. 18 is a graph of octave modulation transfer index at 50 dBA against frequency measured in Hz;

FIG. 19a is a side view of a further embodiment of the invention;

FIG. 19b is a side view of yet another embodiment of the invention;

FIG. 20 is a side view of a further embodiment of the invention incorporating a microphone; and

FIG. 21 is a side view of a further embodiment of the invention incorporating a micro-receiver.

### DETAILED DESCRIPTION

FIGS. 1 to 3 show audio apparatus (10) comprising a transducer (14), a coupler in the form of a clamp (16) and a pad (18). The audio apparatus (10) resembles a conventional clip-on earring. The audio apparatus (10) is connected to a remote sound source, for example a portable personal stereo, etc. via leads (21).

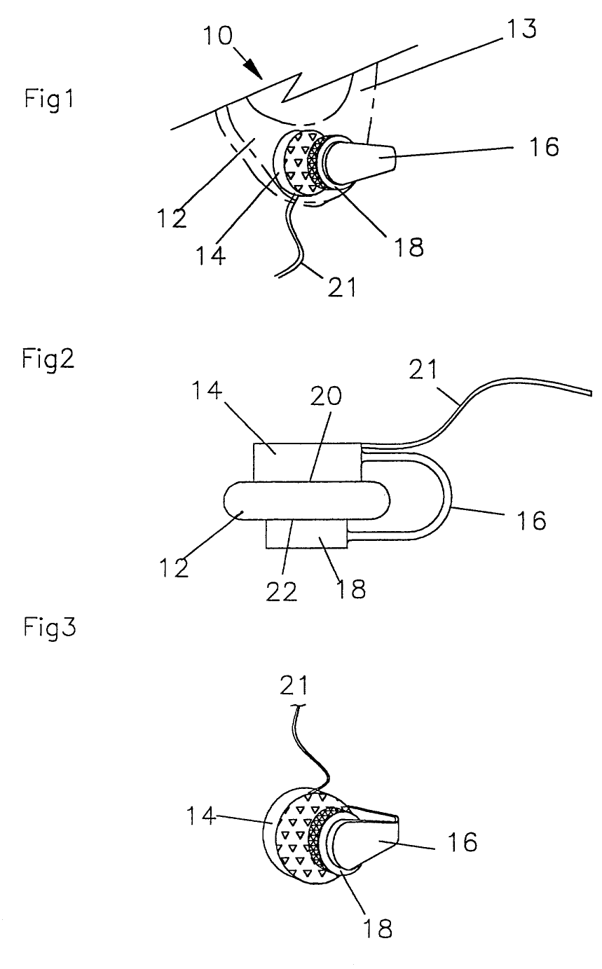

As shown in FIGS. 1 and 2, the audio apparatus is mounted on an ear lobe (12) of an ear (13). The clamp (16) secures the transducer (14) to a first or front face (20) of the ear lobe (12) and the pad (18) to a second or rear face (22) of the ear lobe (12).

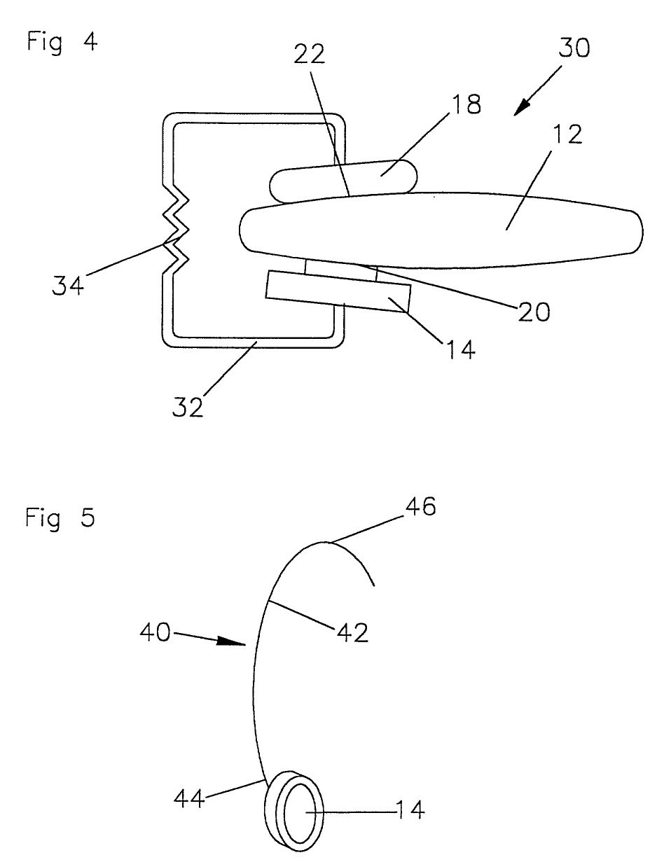

FIG. 4 shows a second audio apparatus (30) comprising an transducer (14), a pad (18) and a coupler in the form of a spring clip (32) comprising a spring (34). The spring clip (32) gently clamps the transducer (14) to a first or front face (20) of the ear lobe (12) and the pad (18) to a second or rear face (22) of the ear lobe (12). The stiffness of the clip (the tension in the spring) has to be carefully chosen so that the device is comfortable to wear but will not fall off.

FIG. 5 shows a third audio apparatus (40) comprising a transducer (14) and a coupler in the form of a hook (42). The transducer (14) is mounted to a first end (44) of the hook (42) and a second end (46) of the hook (42) hooks over the junction (not shown) between the user's ear and head so that the transducer (14) touches a front face of the ear lobe.

The hook (42) is a carefully shaped piece of steel wire which hooks over the joint between the ear and the head. Alternatively the hook may be made of plastics or some rubberised material. The transducer (14) is orientated so that when the hook (42) is comfortably in place it contacts the ear lobe.

The transducer (14) of each embodiment discussed previously is an 11mm transducer made by Shinwoo which is one of the smallest transducers currently available. In tests the tonal balance was good and the frequency response was well extended giving subjective low frequency extension to at least 80 Hz. Alternatively, a 19 mm NEC Authentic transducer may be used to give a greater low frequency extension (subjectively to at least 40 Hz). The transducer may be any appropriate device which excites vibration in the ear lobe and the transducer is chosen according to its physical, mechanical and electromechanical properties. Increasing the transducer size may improve the low frequency response but may also decrease user comfort.

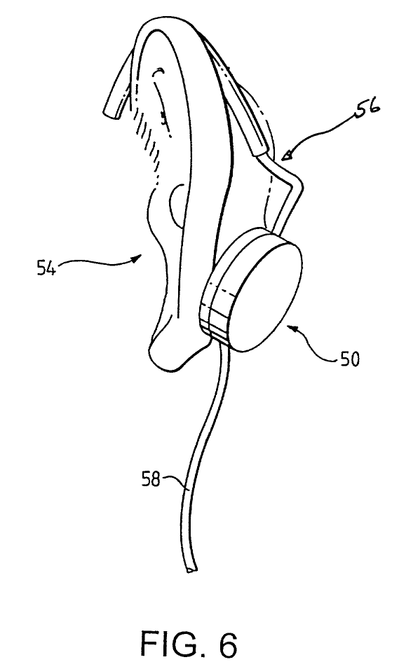

FIGS. 6 to 8 show audio apparatus (50) comprising a transducer (52), a coupler in the form of a hook (56) and leads (58) to connect the audio apparatus (50) to a remote sound source. The transducer (52) is mounted to a lower straight end (80) of the hook (56). An upper curved end (78) of the hook (56) hooks over the junction between the user's ear and head so that the transducer (52) touches a lower rear face of the pinna (54) adjacent the concha. The transducer excites vibration in the pinna whereby an acoustic signal from the transducer is transmitted to the user's inner ear by radiation of pressure waves from the pinna and/or by conduction of vibrational energy through the outer and middle ear.

By mounting the transducer behind the ear, the audio apparatus is unobtrusive, discreet, and does not obstruct or distort the shape of the pinna. Furthermore, the transducer is distanced from and thus does not impede the entrance to the ear canal and thus normal hearing is not affected. Much of the pinna becomes a key acoustic element in the sound reproduction chain. The transducer is mounted above the ear lobe but below the helix canal of the ear. The hook (56) is made of metal with a cover over the upper end (78) where the hook (56) rests on the user's ear.

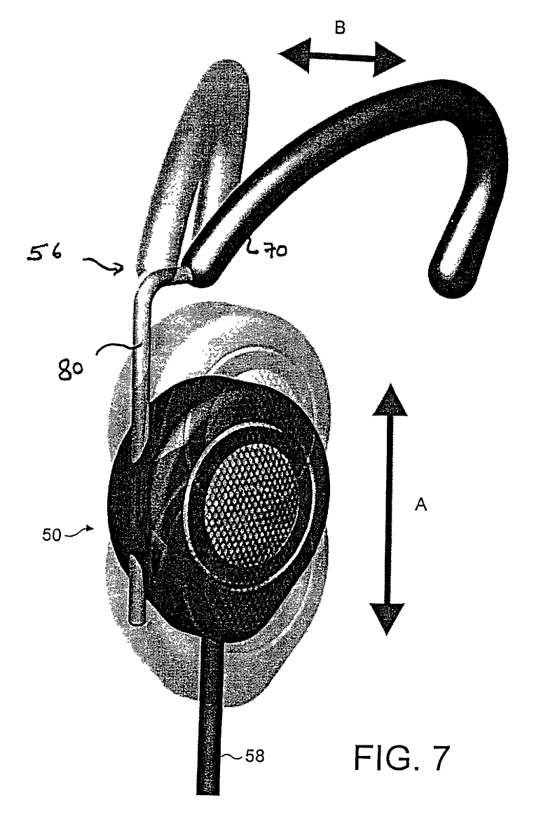

As shown more clearly in FIG. 7, the transducer (52) is slidably mounted on the lower end of the hook so that the transducer may be moved up or down the straight section or lower end (80) of the hook (56). In this way, the vertical position of the transducer relative to the pinna is adjustable in the direction of arrow A. Furthermore, the hook (56) is rotatable relative to the transducer (52) so that the upper end (78) of the hook is movable in the direction of arrow B. Thus, the position of the transducer (52) relative to a user's ear and the position of the upper end (78) of the hook may be adjusted for comfort and for optimum performance.

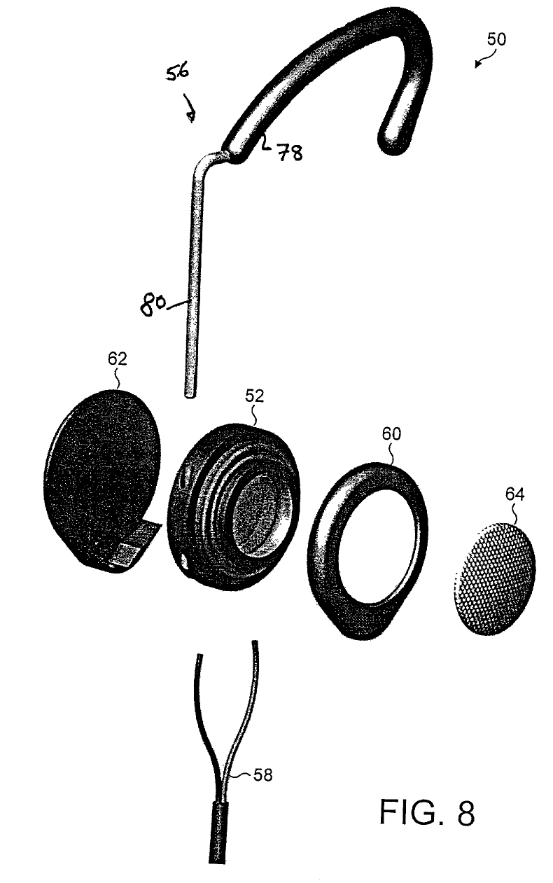

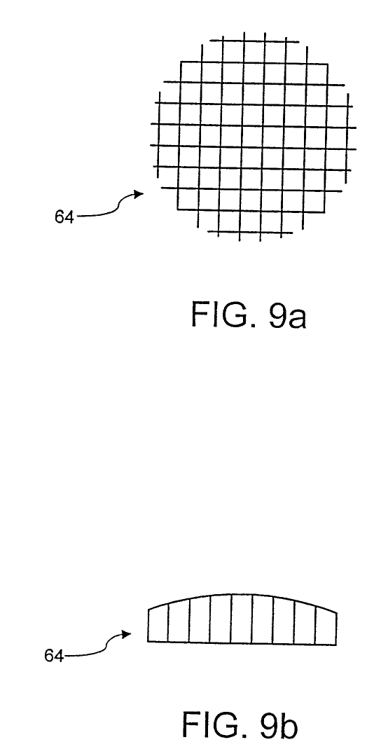

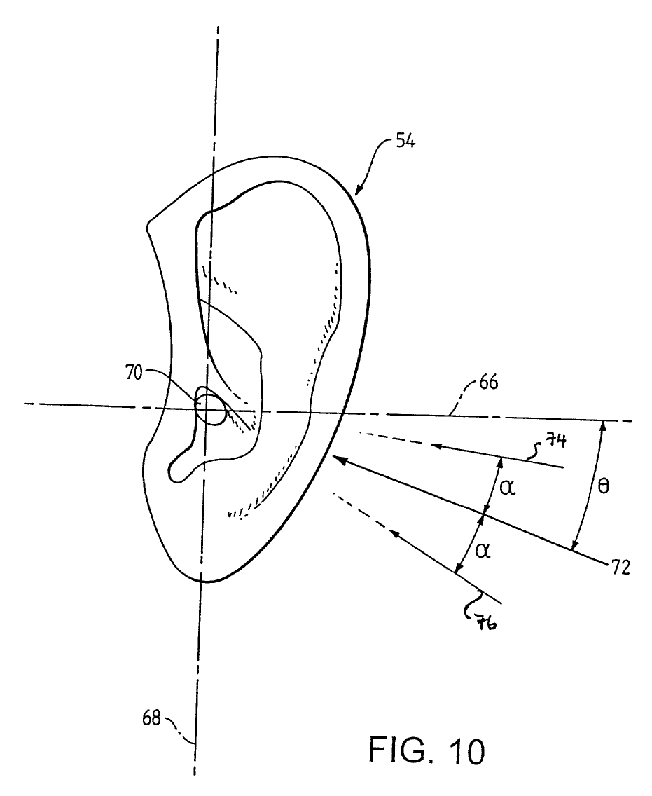

As shown in FIG. 8 the transducer (52) is mounted between a front cover (60) and a rear cover (62). A coupler (64) in the form of a cover screen is mounted to the transducer (52), the coupler (64) transmitting mechanical vibration from the transducer (52) to the pinna. The detail of a preferred embodiment of the coupler (64) is shown in FIGS. 9a and 9b. The coupler (64) has a substantially circular domed shape which may be shaped to fit the shape of a user's ear. The coupler (64) has a lattice structure so that acoustic radiation therefrom is minimised and the coupler thus does not act as a diaphragm. Furthermore, the lattice structure provides low mass and high stiffness in the direction of the force from the transducer whereby mechanical force to the pinna may be maximised.

The coupler (64) may be considered analogous to the mechanical matching of the malleus, incus and stapes with the pinna acting like an external ear drum. The distribution of vibration over the pinna allows a mix of near-field direct sound radiation and coupling to the hard wall of the ear canal which may endow the audio apparatus with a seemingly natural transduction mechanism.

FIG. 10 shows how the location of the transducer on the pinna may be adjusted for each individual user to provide optimal tonal balance or to optimise other features of the acoustic response. By optimising the location of the transducer, the pinna and the transducer may in effect form a combined driver which is unique to an individual user. The optimal position is measured by determining the angle θ between a central radial line (72) and a horizontal axis (66) both extending through the entrance (70) to the ear canal. The central radial line (72) corresponds to the central axis of the transducer and gives the optimal position for the transducer for a first user.

Upper and lower radial lines (74, 76) both at an angle α to the central radial line (72) show the extent of possible deviation from the central radial line (72) which may lead to the optimum position for a second user. Tests have been conducted which give a value for θ of 25° and for α of 16°. The audio apparatus may comprise a built-in facility to locate the optimum position. The adjustment to the angle may be made by combined movement of the transducer and upper end of the hook in the directions of arrows A and B as described above. As an alternative to using the horizontal axis, the angle may be measured relative to a vertical axis (68) extending through the entrance (70) to the ear canal.

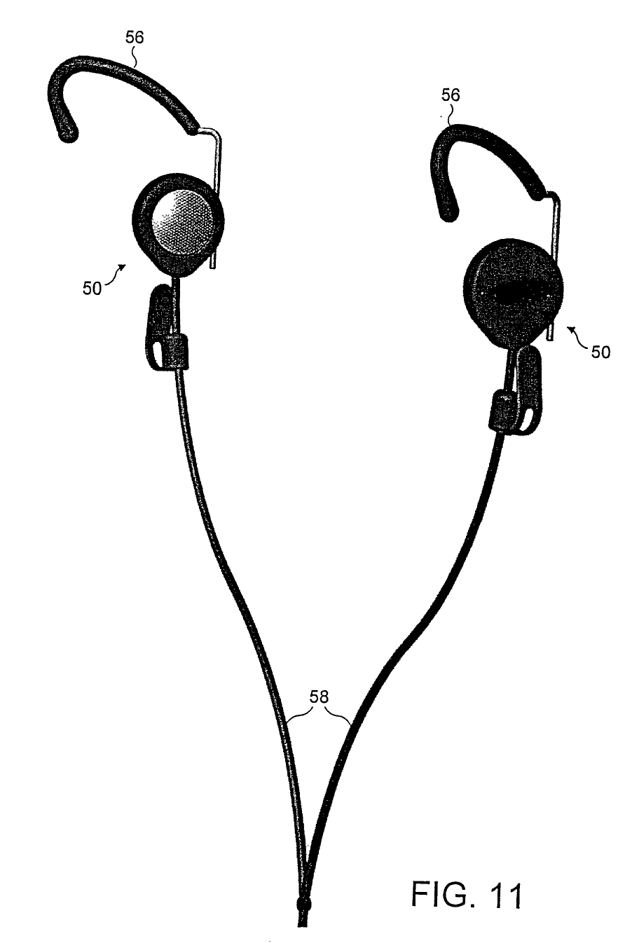

FIG. 11 shows a pair of audio apparatus (50) which are attached to each ear of a user by a respective hook (56). The signal input may be different to each audio apparatus, for example, to create a correlated stereo image. Alternatively, the signal input may be the same for both audio apparatuses.

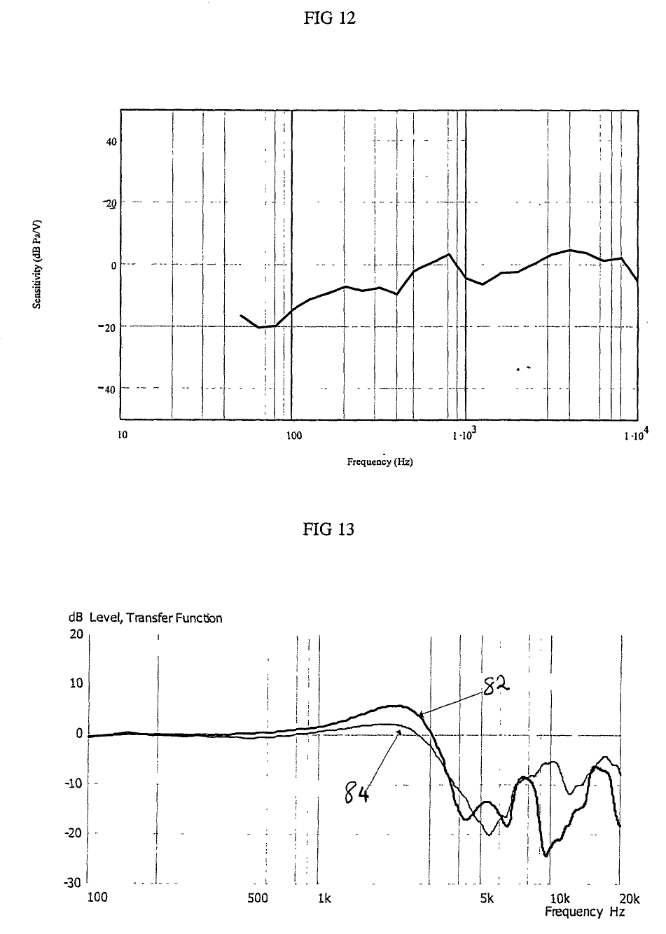

FIG. 12 shows a graph of the frequency response for an audio apparatus according to the present invention, for example the embodiment of FIG. 6. The graph shows sensitivity (Pa/V) against frequency (Hz). The frequency response is measured using a subjective loudness balance technique by comparison with bands of one-third octave filtered pink noise delivered via a conventional headphone with known sensitivity. The technique involves playing a signal having one-third octave bands of uncorrelated noise on left and right channels. One channel is fed to the conventional headphone worn on one ear and the other channel is fed to the audio apparatus according to the present invention on the other ear. A user is able to adjust the relative levels of the two signals until a subjective balance is achieved. This is done for each one-third octave band until a frequency response profile of the audio apparatus according to the present invention is generated, such as that shown in FIG. 12.

The low frequency performance is governed by the parameters of the transducer. In general, greater inertial mass supplied by the magnet assembly and/or higher compliance will extend the low frequency performance at the cost of having a heavier apparatus.

One of the key advantages of audio apparatus according to the present invention, particularly the embodiment of FIG. 6, is that there is reduced occlusion of the external ear and hence reduced or no localisation errors when compared to conventional headphones which occlude the ear to varying degrees. The location of a real sound source is determined by several factors, including inter-aural arrival time, intensity differences, spectral composition due to head shadow and/or pinna effects and changes to all of the aforementioned factors by head or source movements.

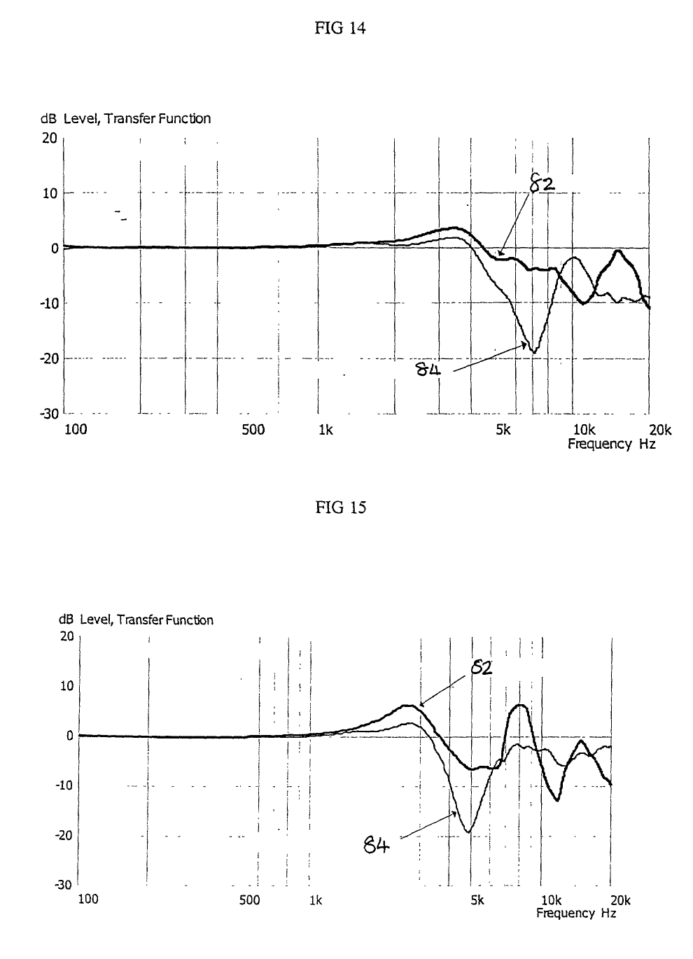

FIGS. 13 to 15 show attenuation curves (transfer function level measured in decibel against frequency in hertz) for three commonly available headsets, comprising respectively supra-aural, supra-concha and intra-concha earphones. The supra-aural earphone rests on the pinna and has an external diameter of at least 45 mm. The supra-concha earphone rests upon the ridges of the concha cavity and has an external diameter of between 25 mm and 45 mm. The intra-concha earphone rests within the concha cavity but does not enter the ear canal and has a maximum dimension of 25 mm.

In all cases there is modification of the local room sounds as a function of frequency and there is a 4 to 6 dB increase in the sensitive 2 to 3 kHz hearing region. This rise will occur for both local ambient noise and speech. The line (82) depicts a sound source angle of incidence of 0 degrees to the median plane, i.e. directly towards the front of a user's head. The line (84) depicts a sound source angle of incidence of 90 degrees to the median plane, i.e. directly towards the front of a user's left ear. All sound sources are at 0 degrees elevation.

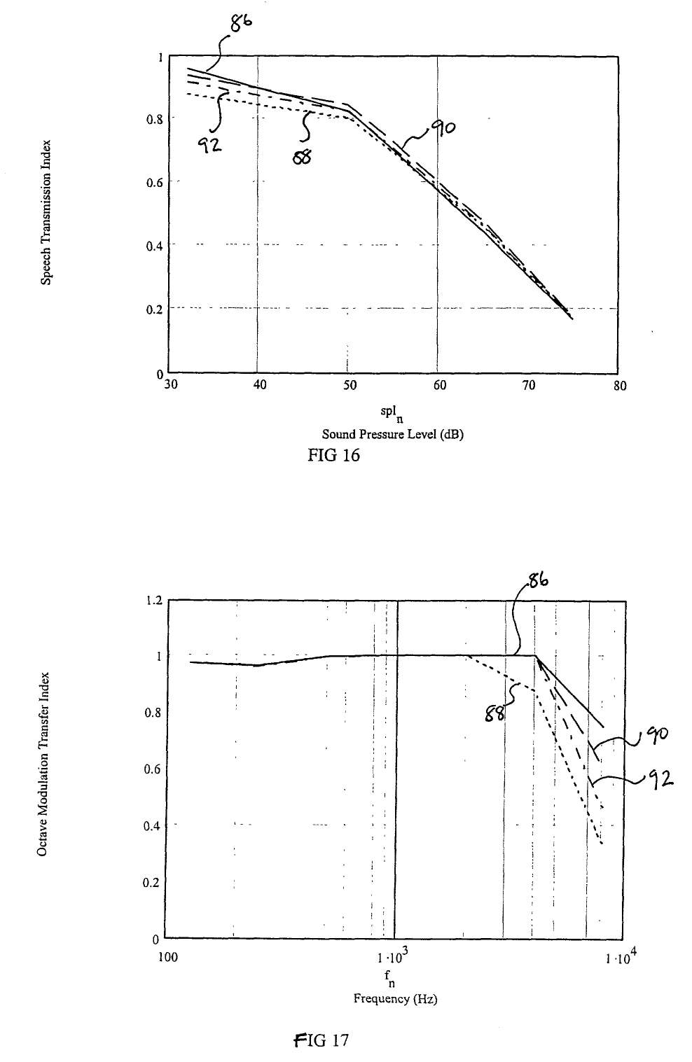

FIGS. 16 to 18 compare a user's ability to locate a sound source when wearing audio apparatus according to the invention with that when wearing the conventional headsets. For all Figures, the lines plotted (86, 88, 90, 82) represent respectively audio apparatus according to the present invention or headsets comprising supra-aural, supra-concha or intra-concha earphones. The speech transmission index was measured on a head and torso simulator in noisy conditions and is derived from octave modulation transfer indexes measured at 32, 50, 65 and 75 dBA.

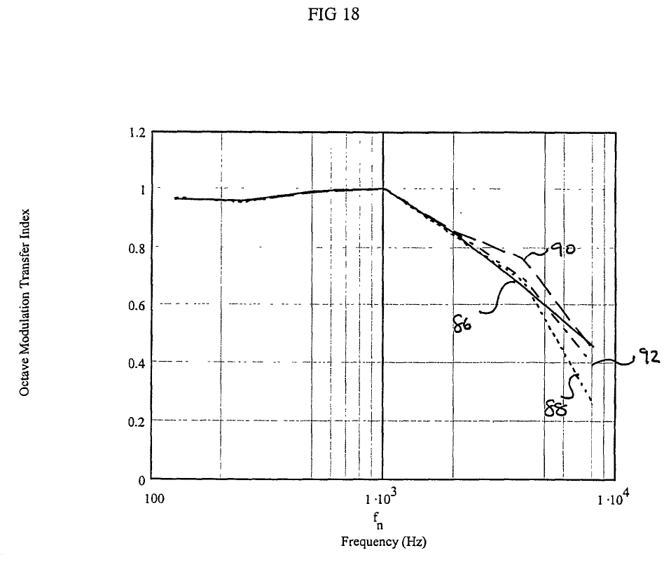

FIG. 16 shows that at lower noise levels, for example under 50 decibels, the speech transmission index is higher for audio apparatus according to the present invention. There is little difference between the headsets at higher noise levels. FIGS. 17 and 18 show the octave modulation transfer indexes at 32 and 50 dBA respectively. In both Figures, the fall-off in the octave modulation transfer index is smaller for audio apparatus according to the present invention than for the conventional headsets. There is a thus greater contribution to the speech transmission index at the 8 Khz octave band for the audio apparatus according to the present invention.

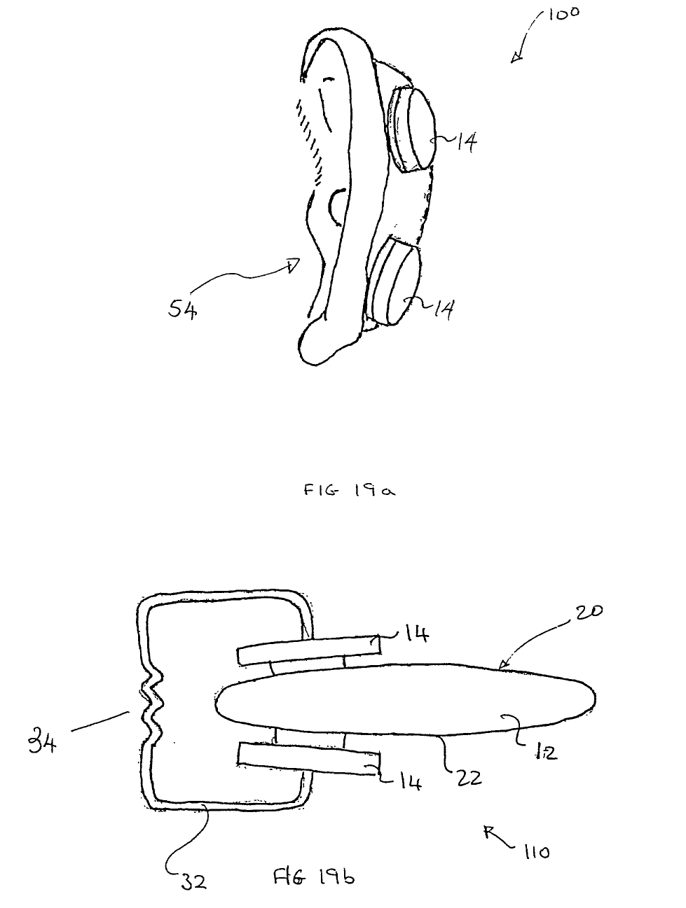

FIGS. 19a and 19b show two audio apparatuses (100, 110) each comprising two transducers (14). In FIG. 19a, the two transducers (14) are mounted directly to a rear face of a user's pinna (54). The transducers (14) are held in place by hooks (not shown) as in the embodiment shown in FIG. 6. The embodiment shown in FIG. 19b is similar to that shown in FIG. 4 and thus elements in common have the same reference number. The spring clip (32) gently clamps a first transducer (14) to a front face (20) of the ear lobe (12) and a second transducer (14) to a rear face (22) of the ear lobe (12). The two transducers are wired in anti-phase or wired to operate in push-pull mode.

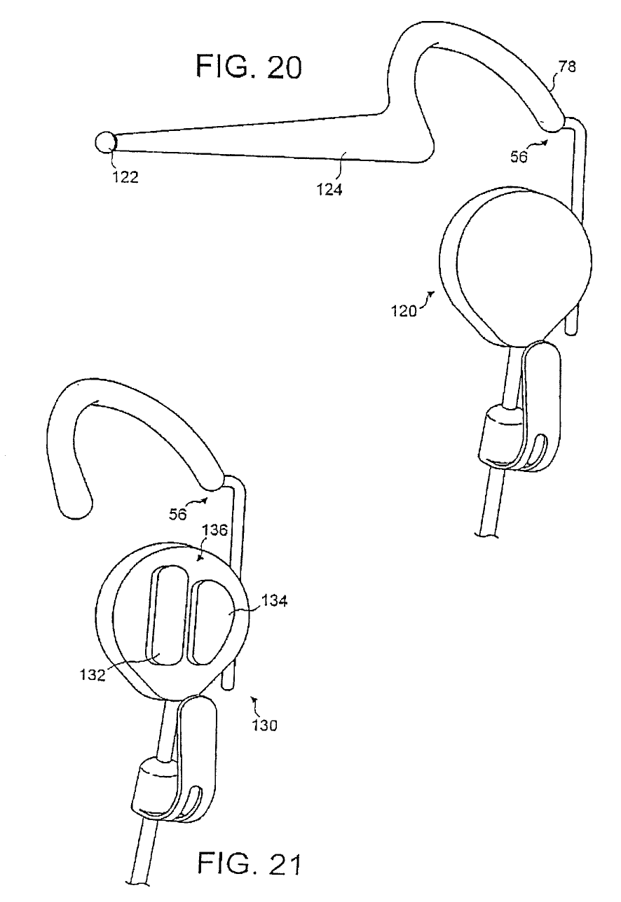

FIGS. 20 and 21 show audio apparatus (120, 130) comprising a transducer (14) mounted on a hook (56). In FIG. 20, the audio apparatus further comprises a microphone (122) mounted on an end of a boom (124) which is attached to the upper end (78) of the hook (56). In FIG. 21, the audio apparatus further comprises a micro-receiver (132) and a power source (134) attached to a rear face (136) of the transducer (14).

1. Audio apparatus comprising a transducer and a coupling means for coupling the transducer to a user's pinna whereby the transducer excites vibration in the pinna to cause it to transmit an acoustic signal from the transducer to the user's inner ear.

2. Audio apparatus according to claim 1, wherein transmission is by radiation of pressure waves from the pinna.

3. Audio apparatus according to claim 1 or claim 2, wherein transmission is by conduction of vibrational energy through the outer and middle ear.

4. Audio apparatus according to claim 1 or claim 2, wherein transmission of acoustic signal is by both conduction and radiation.

5. Audio apparatus according to claim 1, wherein the transducer is coupled to an ear lobe of the pinna.

6. Audio apparatus according to claim 1, wherein the transducer is coupled to a rear face of the pinna adjacent a user's concha.

7. Audio apparatus according to claim 1, claim 5 or claim 6, wherein the transducer is a wide bandwidth low driving mass transducer.

8. Audio apparatus according to claim 7, wherein the transducer has a diameter which is less than 20 mm.

9. Audio apparatus according to claim 8, wherein the transducer diameter is less than 15 mm.

10. Audio apparatus according to claim 7, wherein the transducer is mechanically coupled to the pinna by the coupling means.

11. Audio apparatus according to claim 10, wherein the coupling means has a lattice structure which minimises acoustic radiation therefrom.

12. Audio apparatus according to claim 11, wherein the coupling means has low mass and high stiffness in the direction of the force from the transducer whereby mechanical force to the pinna is maximised.

13. Audio apparatus according to claim 10, wherein the coupling means has low mass and high stiffness in the direction of the force from the transducer whereby mechanical force to the pinna is maximised.

14. Audio apparatus according to claim 7, wherein the audio apparatus comprises a built-in facility to locate the optimum location of the transducer on the pinna for each individual user.

15. Audio apparatus according to claim 1, comprising a second transducer mounted to a second location on the pinna.

16. Audio apparatus according to claim 15, wherein the transducers are mounted to opposing faces of the pinna.

17. Audio apparatus according to claim 1, wherein the coupling means is in the form of a spring clip.

18. Audio apparatus according to claim 1, wherein the coupling means is in the form of a hook, an upper end of which hooks over an upper surface of the ear and a lower end on which the transducer is mounted whereby the transducer contacts a lower part of the pinna.

19. Audio apparatus according to claim 18, wherein the transducer is slidably mounted on the lower end of the hook whereby the vertical position of the transducer relative to the pinna is adjustable.

20. Audio apparatus according to claim 18 or claim 19, wherein the upper end of the hook is rotatable relative to the transducer.

21. Audio apparatus according to claim 1, comprising a miniature built in microphone.

22. Audio apparatus according to claim 1, comprising a built in micro receiver for a wireless link to a sound source.

23. Audio apparatus according to claim 1, wherein the audio apparatus comprises a built-in facility to locate the optimum location of the transducer on the pinna for each individual user.

24. An audio system comprising two audio apparatuses according to claim 7, each audio apparatus being mounted on a respective ear of a user.

25. An audio system according to claim 24, wherein each audio apparatus is supplied with an appropriate stereo channel to create a correlated stereo image.

26. An audio system according to claim 25, wherein each audio apparatus is supplied with the same signal input.

27. An audio system comprising two audio apparatuses according to claim 1, each audio apparatus being mounted on a respective ear of a user.

28. A method of applying an audio signal to a human or animal subject comprising mechanically coupling a transducer to the subject's pinna and driving the transducer so that the transducer excites vibration in the pinna to cause it to transmit an acoustic signal from the transducer to the subject's inner ear.

29. A method according to claim 28, comprising transmitting by radiation of pressure waves from the pinna.

30. A method according to claim 28 or claim 29, comprising transmitting by conduction of vibrational energy through the outer and middle ear.

31. A method according to claim 28 or claim 29, comprising transmitting by both radiation and conduction.

32. A method according to claim 28, comprising adjusting the location of the transducer on the pinna to optimise acoustic performance for an individual subject.

33. A method according to claim 32, comprising measuring the optimal position by determining the angle between a horizontal axis extending through an entrance to an ear canal and a radial line which extends through the entrance and which corresponds to the central axis of the transducer.

34. A method according to claim 33, wherein the angle is in the range of 9 to 41 degrees below the horizontal axis.
